(19) United States
(12) Patent Application Publication
(10) Pub. No.: US 2009/0259540 A1
(43) Pub. Date: Oct. 15, 2009

(54) SYSTEM FOR PARTITIONING AND PRUNING OF ADVERTISEMENTS

(75) Inventor: Thomas Phan, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/103,636

(22) Filed: Apr. 15, 2008

(51) Int. Cl. G06Q 30/00

(52) U.S. Cl. 705/14

(57) ABSTRACT

A system is disclosed for selecting advertisements for delivery. The system may be configured to assign the advertisements to categories. The system also may be configured to deliver the advertisements according to a frequency assigned to each category.

### FIELD OF THE INVENTION

Generally a method and system is disclosed for selecting advertisements.

### BACKGROUND

In online Internet advertising, an advertiser produces an offer and a creative. The advertiser then hires a web publishing company (like Yahoo!® or Google™) to deliver the offer and creative to end users. These creatives can take the form of text-based content or graphical banners. In either cases the creative and offer are provided by the advertiser prior to the start of the advertising campaign. Another type of online ad is a templatized graphical advertisement, where a graphical template is delivered to the user along with a dynamically-generated offer specific to the attributes of the user. An example of such a templatized graphical advertising product is Yahoo! Smart Ads™, and an example of a dynamic offer is where an airline provides a customized offer with a destination at a given price for users who show interest. While such a system is able to deliver customized offers to the appropriate users, it may still not be able to generate a sufficiently high click-through rate (CTR) to satisfy the advertiser. Generally, it is desirable to increase the CTR by way of delivering good offers more often and poor offers less often.

In online advertising, the primary metric for determining the success of an ad campaign is the CTR, which is the ratio of the number of times that a user clicks on an ad to the total number of ad impressions seen. From the point of view of the online publisher delivering the ads (such as Yahoo!®), raising the CTR serves a dual purpose: (1) for branding campaigns where ads are guaranteed to be delivered, a high CTR demonstrates to the advertiser that the publisher is doing a good job placing the ads in front of interested users; and (2) for pay-per-click campaigns where the advertiser pays for each click, a high CTR results in more revenue for the publisher. In general, it is in the best interest of the advertiser and publisher to generate a high CTR.

### SUMMARY

The system provides an increased CTR for advertisement campaigns, especially dynamic templatized advertisements. The CTR measurement is an important indicator of the effectiveness of an advertising campaign. In dynamic templatized advertising campaigns, offers are dynamically generated to meet user targeting. To increase the CTR, a partitioning and pruning scheme may be implemented. As such the system may partition offers into categories based on their historic CTR performance. The low-CTR offers may then be probabilistically pruned away in order to raise the overall CTR of the entire campaign.

The system may include a web server, an advertisement database, and a advertisement delivery module. The advertisement database providing the advertisement delivery module access to advertisements and the advertisement delivery module delivering the advertisements to the web server. The advertisement delivery module categorizes the advertisements and delivers the advertisements according to a frequency assigned to each category.

In another aspect, the advertisement delivery module categorizes the advertisements based on the CTR of the advertisement, the impressions of an advertisement, a target CTR, and a threshold number of impressions. For example, the advertisements may be classified based on a comparison of the advertisement CTR relative to the target CTR and a comparison of the advertisement impressions relative to an impression threshold.

In yet another aspect, the advertisement delivery module calculates a delivery frequency for each category based on the CTR of each category, a target CTR, and a category ratio, or some combination thereof.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

FIG. 1 is a schematic view of a system for selecting advertisements;

FIG. 2 is a flowchart illustrating a method of selecting advertisements; and

FIG. 3 is a flowchart illustrating a method of determining a selection frequency for categories of advertisments.

### DETAILED DESCRIPTION

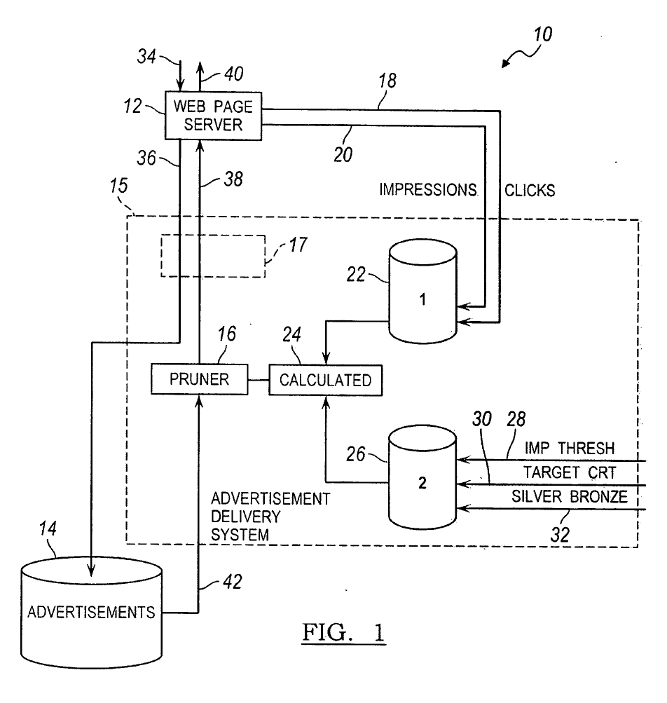

Referring now to FIG. 1, a system 10 is provided that embodies principles of the present application. The system 10 includes a web page server 12, an advertisement database 14, and an advertisement delivery system 15. The web page server 12 may receive data from a user or a host system as denoted by line 34. The user data 34 may be in the form of a search query, contextual page information, user navigational information, or historical user information. The user data 34 generally indicates user interests, preferences, intentions, etc. that may be used for selecting an advertisement. Such data may be stored in memory for that session, stored in cookies on the host computer, or stored in a user profile on the web server. Accordingly, the data 36 may include the user data 34 and web page data. The data 36 is provided from the web page server 12 to the advertisement delivery system 15.

In one embodiment, the data 36 may be provided to an advertisement selection module 17 to determine the current interest or relevant historical interests of the user to select an advertisement from the advertisement database 14 corresponding to the data 36. The advertisement database 14 provides advertisements to the advertisement delivery system 15, as denoted by line 42. The advertisements 42 may be provided to a pruner module 16 to control the frequency of display of a particular advertisement or category of advertisement in the advertisement campaign. The advertisement may be one of a plurality of advertisements. In a particularly useful scenario, the advertisements may be particular offers of a dynamic templatized advertisement campaign. The selected advertisement may be provided to the web page server 12, for example through the ad selection module 17, as denoted by line 38. The advertisement may then be provided to the user through the host system, as denoted by line 40.

The pruner module 16 may decide to select an advertisement for display based on a number of methods. In one embodiment, a predefined selection frequency of each particular advertisement or advertisement category may be used to select the advertisement for display. In one exemplary method, the web page server 12 provides data about the user's interaction with the advertisement to a first database component 22 of the advertisement delivery module 15. For example, the web page server 12 may provide clicks 18 and impressions 20, related to the advertisement, to the first database component 22. In addition, a second database component 26 may receive advertisement or advertisement campaign information from the advertiser. For example, the information may specify target advertisement criteria that are used to identify the frequency at which certain advertisements within the advertisement campaign should be displayed. The advertisement criteria may include an impression threshold, as denoted by line 28, indicating a number of impressions after which the CTR is considered valid. The second database component 26 may receive a target CTR 30 indicating the target click-through rate for the advertisement campaign. In addition, the second database component 26 may also receive a category ratio, denoted by line 32. The category ratio 32 may identify the ratio of impressions between various advertisement categories.

A calculation component 24 receives data from the first database component 22, such as the clicks 18 and the impressions 20 of an advertisement. Similarly, the calculation component 24 receives advertisement criteria from the second database component 26, such as the impression threshold 28, the target CTR 30, and the category ratio 32. The calculation component 24 separates each advertisement, based on the user data and advertisement criteria, into one of multiple advertisement categories. As noted above, advertisements may be assigned to advertisement categories based on the impressions and the CTR of the advertisement. In one embodiment, the three advertisement categories may be identified and labeled as Gold, Silver, and Bronze. Other amounts and designations of categories may be used, such as depending on an implementation. As such, the calculation module 24 may separate the advertisements into the defined categories and assign a selection frequency for each category to increase and/or maximize the click-through rate of all advertisements in a particular advertisement campaign.

To facilitate categorization and calculation of the selection frequencies for each category, the first database component 22 and second database component 26 may be part of or in communication with the advertisement database 14 or other data modules as necessary. As noted above, the pruner module 16 utilizes the selection frequency of each category and the categorization of each advertisement to determine which advertisements to display. Accordingly, the system serves to increase the click-through rate of the entire advertisement campaign.

The problem of generating a high CTR may be more difficult with templatized ads than non-templatized ads. In non-templatized ads, each creative is typically made prior to the start of the advertising campaign and is meant to focus on a broad concept, such as a brand (e.g. Ford sedans and SUVs) or a single service (e.g. debt consolidation). A goal of templatized ads is to deliver specific offers, which are much more fine-grained. Examples of templatized ads include specific individual items in a catalog (e.g. digital cameras from a retail chain) or specific one-time offers (e.g. a priced airline ticket from a specific city to a specific destination). The volume of possible offers for templatized ads is, thus, much larger than in non-templatized ads. Due to this large volume, the distribution of performance may have a much larger degree of variation, typically resulting in a poor CTR.

From the publisher's perspective, the system should deliver specific offers to users who are most interested in them, such that the likelihood that the user clicks on the ad is increased. A number of ways exist to improve the matching between users and the ads exist. Such methods include targeting based on geography, demographics, and behavior. However, even after ads have been targeted to the users, it may be the case that some offers simply perform very poorly due to the inherent nature of the offer. For example, although a targeting mechanism may do a good job in identifying users who are interested in traveling from San Francisco to Reno, offers for airlines tickets between those two cities may have a low CTR simply because users are much more likely to drive between those cities. The system described herein increases CTR of templatized advertising campaigns by pruning away offers that have a very low CTR, thus raising the overall CTR to a level that satisfies the campaign manager. The primary challenges include: (1) identifying and classifying offers based on their performance; (2) calculating how often each offers should be shown based on its classification; and (3) enforcing the calculated delivery rates of the ads to the users.

In one scenario, the system reads per-offer historical performance, including clicks and impressions. The system may assume that the historical CTR of an offer (with sufficient impressions) may be the same CTR for that offer in the future. Accordingly, the system may classify each offer into categories based on how many impressions the advertisement has received and the CTR of the advertisement. As described above, three categories of advertisements may be defined and, accordingly, the categories may be named Gold, Silver, and Bronze. Other amounts and designations may be used. The system may receive a set of inputs from a campaign manager. The set of inputs may include:, (a) an impression threshold; (b) a target CTR; and (c) a Silver-to-Bronze category ratio. The impression threshold is chosen so that offers with more than this number of impressions have a statistically valid CTR. The resulting delivery frequencies raise the CTR of the advertisement campaign to be at or above the target CTR. The category ratio, in this case the Silver-to-Bronze ratio, is used to adjust the number of impressions for each category.

A method of calculating the frequencies for each category is determined based on the CTR of one or more of the categories. Based on the selected method, the system determines the exact delivery frequencies of the; Gold, Silver, and Bronze categories. The frequencies for each category may be based on the impression threshold, the target CTR, the Silver-to-Bronze ratio, or any combination thereof. The system then delivers the offers to the user at the selection frequencies determined for each category of advertisement.

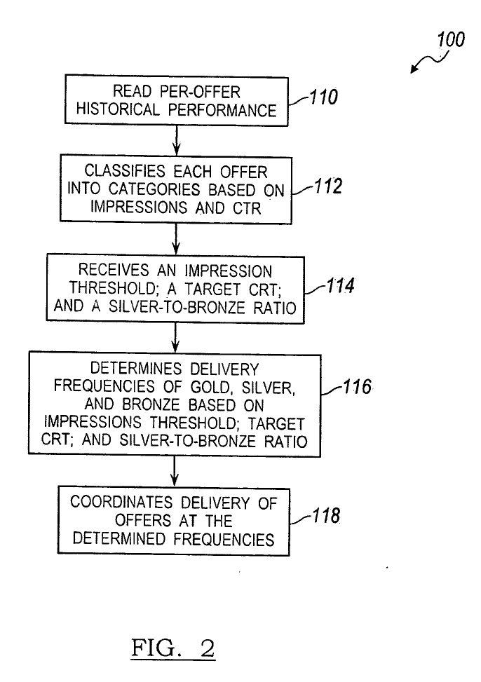

In light of the method described above, one implementation in relation to the system 10 is illustrated in the flowchart 100 of FIG. 2. In step 110, the system reads the per offer historical performance for each advertisement. In block 112, the system classifies each offer into categories based on the number of impressions for that offer and the click-through rate for that offer. In block 114, the system receives an impression threshold, a target click-through rate, and Silver to bronze ratio. In block 116, the system determines delivery frequencies of each category based on the impression threshold, the target click-through rate, and the Silver-to-Bronze ratio. The system then coordinates delivery of the offers at the determined frequencies for each category as denoted by block 118.

In one exemplary embodiment, the offers from a templatized advertising campaign are, initially, run for a set period of time to collect training data. This may be referred to as a training mode. The period of time may vary from a few days to a few weeks. Alternatively, if the same type of campaign with the same set of offers ran in the past, then that data may be used as training data.

Offers can be uniquely identified by a tuple of attributes relevant to the offer and the advertiser. Examples of such a tuple include a combination of origin city and destination city for an airline, or a combination of age, gender, and income level for a retail chain. Offers are then classified into categories. Based on the campaign manager's setting of the impression threshold, offers are classified into Silver or not-Silver. If the offer has received less than the impression threshold, the offer is placed into the Silver category. If the offer is not-Silver, then the offer is classified into Gold or Bronze. If the offer has a CTR higher than or equal to the target CTR, then the offer is placed into the Gold category. Otherwise, the offer is placed into the Bronze category.

At this point, all offers may have been classified. The offers in the Silver category have not received enough impressions yet to determine a statistically-valid CTR. The offers in the Gold category have enough impressions and are known to have a high CTR. However, the offers in the Bronze category have enough impressions, but are known to have a low CTR. Accordingly, it may likely be advantageous to deliver more of the Gold offers and less of the Bronze offers. The calculator module then calculates the respective delivery probabilities of each category so that the pruner module can actively apply these frequencies and affect each offer's rate of delivery. For each offer, the calculator calculates a decimal value in the range of 0 to 1.00, inclusive. A value of 1.00 means that the offer should be delivered 100% of the time, while a value of 0.25 means that offer should be delivered 25% of the time. To provide these values for each offer, the calculator uses the input data from the campaign manager. The manager provides a Silver-to-Bronze ratio which is used in conjunction with the target CTR. The goal in this case may be to raise the CTR of the entire campaign to the target CTR.

In one embodiment, the selection frequencies for each category are defined as provided below. If the campaign is actually already over the target CTR, then no steps are taken. As such, all offers are set to be delivered at 100%. If the CTR from the Gold and Silver offers is over the target CTR, then more impressions of the Bronze category can be added. The system can increase the impressions of the Bronze category, so that the overall CTR is brought down to exactly the target CTR. The number of impressions of the Bronze category can be calculated according to the relationship:

impressions_bronze=((clicks_gold+clicks_silver−target_{—}CTR*impressions_gold−target_{—}CTR*impressions_silver)/(target_{—}CTR−CTR_bronze)

Where impressions_bronze is the number of impressions of advertisements in the Bronze category, clicks_gold is the number of clicks for the advertisements in the Gold category, clicks_silver is the number of clicks for the advertisements in the Silver category, target_CTR is the target click-through rate provided by the advertiser, impressions_gold is the number of impressions of advertisements in the Gold category, impressions silver is the number of impressions of advertisements in the Silver category, and bronze_CTR is the click-through rate of the advertisements in the Bronze categories.

If the CTR from the Gold and Silver offers is below the target CTR, then the calculator cannot add any more Bronze. Increasing Bronze advertisements may make the CTR go even lower. Instead, the calculator decreases both the Silver and Bronze impressions simultaneously, so that the CTR goes down to the target CTR. As such, the Silver and Bronze impressions may be reduced proportionally. Further, the number of Bronze impressions may be calculated based on the relationship:

impressions_bronze=((clicks_gold*impressions_gold)/(target_{—}CTR*silver_to_bronze_ratio+target_{—}CTR−CTR_silver*silver_to_bronze_ratio−CTR_bronze)

Where impressions_bronze is the number of impressions of advertisements in the Bronze category, clicks_gold is the number of clicks for the advertisements in the Gold category, impressions_gold is the number of impressions of advertisements in the Gold category, target_CTR is the target click-through rate provided by the advertiser, silver_to_bronze_ratio is the category ratio provided the advertiser, silver_CTR is the click-through rate of the advertisements in the Silver category, and bronze_CTR is the click-through rate of the advertisements in the Bronze category.

For the scenario described above, the number of silver impressions is then given by:

impressions_silver=silver_to_bronze_ratio*impressions_bronze

Where impressions_silver is the number of impressions of advertisements in the Silver category, silver_to_bronze_ratio is the category ratio provided the advertiser, and impressions_bronze is the number of impressions of advertisements in the Bronze category.

At this point, the number of desired impressions for the Gold, Silver, and Bronze categories are known. Assuming that the Gold category is to never be pruned (its delivery frequency is 100%), then the Silver and Bronze categories' frequencies are calculated to be the ratio of their new number of impressions (calculated as above) divided by the number of impressions they originally received.

Now all offers have a calculated delivery frequency based on their category. This list of frequencies is provided to the pruner module, which serves to actively prune the delivery of the offers according to its respective frequency. This pruning can happen in several ways. In one scenario, the pruner module helps to decide at the time an offer is to be delivered whether or not the offer is actually shown. For example, if an offer is calculated to be delivered 25% of the time, then the pruner may allow the ad to be shown 25% of the time to qualified users (as opposed to the 100% of the time that the ad would have been shown without the pruner). Alternatively, the order of offers may be determined after the selection frequencies are updated.

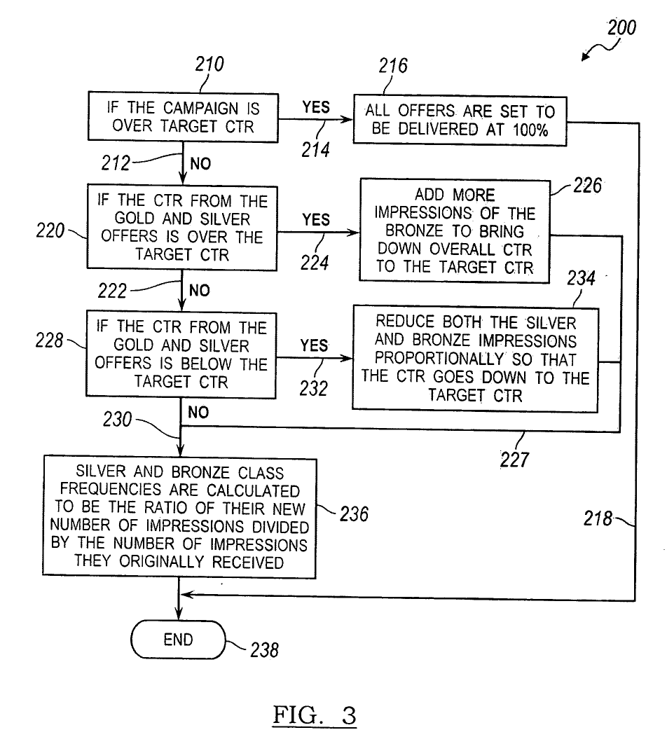

For additional clarity, one implementation of a method 200 for adjusting the frequencies for each category is illustrated in FIG. 3. In block 210, the system determines if the campaign is the target click-through rate. If the campaign is over the target CTR, the method follows line 214 to block 216 where all offers are set to be delivered at 100% frequency. The method then follows line 218 to block 238 where the method ends. If the campaign is not over the target CTR, the method follows line 212 to block 220. If the system determines if the CTR from the Gold and Silver offers is over the target CTR, the method follows line 224 to block 226. In block 226, the system adds more impressions of the bronze category to bring down the overall CTR to the target CTR. The method then follows line 227 to block 236. If the CTR from the Gold and Silver offers is not over the target CTR, the method follows line 222 to block 228. In block 228, the system determines if the CTR from the Gold and Silver offers is below the CTR. If the CTR from the Gold and Silver offers is below the CTR, the method follows line 232 to block 234. In block 234, the system reduces both the Silver and bronze impressions proportionally so that the CTR goes down to the target CTR. The method then follows line 227 to block 236. If the CTR from the Gold and Silver offers is not below the target CTR, the line follows line 230 to block 236. In block 236, the Silver and bronze category frequencies are calculated to be the ratio of their new number of impressions divided by the number of impressions they originally received. The method then proceeds to block 238 where the method ends.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law; the scope is to be determined by the broadest permissible interpretation of the following claims and their equivalents, and shall not be restricted or limited by the foregoing detailed description.

I claim:

1. A system for selecting an advertisement of a plurality of advertisements, the system comprising:
a web server for delivering the advertisement;
an advertisement database for storing the plurality of advertisements;
an advertisement delivery module being in communication with the advertisement database to access the plurality of advertisements, the advertisement delivery module including a calculation module and a pruning module, the calculation module configured to classify the plurality of advertisements from an advertisement campaign into a category of a plurality of categories, each category of the plurality of categories having a selection frequency, the pruning module configured to select the advertisement based on the selection frequency of each category and deliver the advertisement to the web server.

2. The system according to claim 1, wherein the category of each advertisement is determined based on a number of impressions of the advertisement.

3. The system according to claim 1, wherein the category of each advertisement is determined based on a target click-through rate.

4. The system according to claim 1, wherein the category of each advertisement is determined based on click-through rate of the advertisement.

5. The system according to claim 1, wherein the selection frequency of each category is determined based on a target click-through rate for the advertisement campaign.

6. The system according to claim 1, wherein the selection frequency of each category is determined based on a click-through rate for at least one category of the plurality of categories.

7. The system according to claim 1, wherein the selection frequency of each category is determined based on a category ratio for the advertisement campaign.

8. The system according to claim 1, wherein the selection frequency of each category is set to 100% if a click-through rate for all of the categories is above a target click-through rate.

9. The system according to claim 1, wherein the selection frequency of one category of set of categories is increased if the click-through rate for the set of categories is above the target click-through rate.

10. The system according to claim 9, wherein the selection frequency is calculated based on the relationship:
impressions_bronze=((clicks_gold+clicks_silver−target_{—}CTR*impressions_gold−target_{—}CTR*impressions_silver)/(target_{—}CTR−CTR_bronze).

11. The system according to claim 1, wherein the selection frequency of a set of categories is reduced proportionally if a click-through rate for the set of categories is below a target click-through rate.

12. The system according to claim 11, wherein the selection frequency is calculated based on the relationship:
impressions_bronze=((clicks_gold*impressions_gold)/(target_{—}CTR*silver_to_bronze_ratio+target_{—}CTR−CTR_silver*silver_to_bronze_ratio−CTR_bronze).

13. The system according to claim 1, wherein the advertisement is categorized in a first category if a number of impressions for the advertisement is below a threshold number of impressions.

14. The system according to claim 13, wherein the advertisement is categorized in a second category if the number of impressions for the advertisement is above the threshold number of impressions and a click-through rate for the advertisement is above a target click-through rate.

15. The system according to claim 14, wherein the advertisement is categorized in a third category if the number of impressions for the advertisement is above the threshold number of impressions and the click-through rate is below a target click-through rate.

16. A method for selecting an advertisement, the method comprising
classifying a plurality of advertisements from an advertisement campaign into a category of a plurality of categories;
calculating a selection frequency for each category; and
delivering the advertisements based on the selection frequency of each category.

17. The method according to claim 16, wherein the category of each advertisement is determined based on a number of impressions of the advertisement, a click-through rate of the advertisement, and a target click-through rate for the advertisement campaign.

18. The method according to claim 16, wherein the selection frequency of each category is determined based on a target click-through rate for the advertisement campaign, a click-through rate for at least one of the categories, and a category ratio for the advertisement campaign.

19. The method according to claim 16, wherein the selection frequency of each category is set to 100% if a click-through rate for all of the categories is above a target threshold rate.

20. The method according to claim 16, wherein the selection frequency of one category of a set of categories is increased if a click-through rate for the set of categories is above a target click-through rate.

21. The method according to claim 20, wherein the selection frequency is calculated based on the relationship:
impressions_bronze=((clicks_gold+clicks_silver−target_{—}CTR*impressions_gold−target_{—}CTR*impressions_silver)/(target_{—}CTR−CTR_bronze).

22. The method according to claim 16, wherein the selection frequency of a set of categories is reduced proportionally if a click-through rate for the set of categories is below a target click-through rate.

23. The method according to claim 22, wherein the selection frequency is calculated based on the relationship:
impressions_bronze=((clicks_gold*impressions_gold)/(target_{—}CTR*silver_to_bronze_ratio+target_{—}CTR−CTR_silver*silver_to_bronze_ratio−CTR_bronze).

24. The method according to claim 16, wherein the advertisement is categorized in a first category if a number of impressions for the advertisement is below a threshold number of impressions, the advertisement being categorized in a second category if the number of impressions for the advertisement is above the threshold number of impressions and a click-through rate is above a target click-through rate, and the advertisement being categorized in a third category if the number of impressions for the advertisement is above the threshold number of impressions and the click-through rate is below a target click-through rate.

25. A computer readable medium having stored therein instructions executable by a programmed processor for selecting an advertisement, the storage medium comprising instructions for:
classifying a plurality of advertisements from an advertisement campaign into a category of a plurality of categories;
calculating a selection frequency for each category; and
delivering the advertisements based on the selection frequency of each category.

26. The computer readable medium according to claim 25, wherein the category of each advertisement is determined based on a number of impressions of the advertisement, a click-through rate of the advertisement, and a target click-through rate for the advertisement campaign.

27. The computer readable medium according to claim 25, wherein the selection frequency of each category is determined based on a: target click-through rate for the advertisement campaign, a click-through rate for at least one of the categories, and a category ratio for the advertisement campaign.

28. The computer readable medium according to claim 25, wherein the selection frequency of each category is set to 100% if a click-through rate for all of the categories is above the target threshold rate.

29. The computer readable medium according to claim 25, wherein the selection frequency of one category of a set of categories is increased if a click-through rate for a set of categories is above a target click-through rate.

30. The computer readable medium according to claim 29, wherein the selection frequency is calculated based on the relationship:
impressions_bronze=((clicks_gold+clicks_silver−target_{—}CTR*impressions_gold−target_{—}CTR*impressions_silver)/(target_{—}CTR−CTR_bronze).

31. The computer readable medium according to claim 25, wherein the selection frequency of a set of categories is reduced proportionally if a click-through rate for the set of categories is below a target click-through rate.

32. The computer readable medium according to claim 31, wherein the selection frequency is calculated based on the relationship:
impressions_bronze=((clicks_gold*impressions_gold)/(target_{—}CTR*silver_to_bronze_ratio+target_{—}CTR−CTR_silver*silver_to_bronze_ratio−CTR_bronze).

33. The computer readable medium according to claim 25, wherein the advertisement is categorized in a first category if a number of impressions for the advertisement is below a threshold number of impressions, the advertisement being categorized in a second category if the number of impressions for the advertisement is above the threshold number of impressions and a click-through rate is above a target click-through rate, and the advertisement being categorized in a third category if the number of impressions for the advertisement is above the threshold number of impressions and the click-through rate is below a target click-through rate.
